(19) United States
(12) Patent Application Publication
(10) Pub. No.: US 2006/0044596 A1
(43) Pub. Date: Mar. 2, 2006

(54) Method for printing

(76) Inventor: Ken Ota, Foster City, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/926,352

(22) Filed: Aug. 26, 2004

(51) Int. Cl. G06F 15/00

(52) U.S. Cl. 358/1.15; 358/1.1

(57) ABSTRACT

The present application relates to a printing system to allow a user to print a lot of documents in a short time.

### FIELD

The present invention relates to a method of printing using several printers.

Introduction

Printers such as laser printers are widely used for printing documents produced by a personal computer. By recent development, printing speed of the printers becomes faster. However, when a lot of prints are printed by the printer, it still takes pretty long time. Therefore, it is desirable to shorten the printing time for printing a lot of documents by the printer.

### SUMMARY

According to various embodiments, the present teachings can provide a method for printing by a system comprising at least one computer and a first printer and a second printer, comprising a print data producing step which produces a print data by the computer, a print job producing step which produces a print job according to the print data, a first transferring step which transfers the print job from the computer to the first printer, a second transferring step which transfers the print job from the first printer to the second printer which is connected to the first printer, and a printing step which prints according to the print job by the first printer and the second printer, and wherein the first printer and the second printer are configured to be abole to use same page description language (PDL).

### BRIEF DESCRIPTION OF THE DRAWINGS

FIG. 1 illustrates a block diagram of a printing system, according to certain embodiments.

### DESCRIPTION OF CERTAIN EMBODIMENTS

A printing system comprises at least one computer, a first printer and a second printer.

In certain embodiments, the computer, the first printer and the second printer can be apart as different units and be connected with each other. In certain embodiments, the computer, the first printer and the second printer can be connected with a cable. Examples of the cable consistent with certain embodiments of the invention include, but are not limited to, a twisted pair cable, an optical fiber and a coaxial cable. In certain embodiments, the computer, the first printer and the second printer can be connected wirelessly. Examples of wireless transmission consistent with certain embodiments of the invention include, but are not limited to, radio frequency (“RF”) and/or infrared (“IR”) transmission. In certain embodiments, the computer, the first printer and the second printer can be connected through LAN, Internet and the like.

The computer produces a print data. Examples of the computer consistent with certain embodiments of the invention include, but are not limited to, a personal computer (e.g. PC/AT compatible machine, Macintosh and so on), a super computer and a server. In certain embodiments, the print data can include data of document, text, drawing, picture and so on. In certain embodiments, the print data can include the contents of the document, size of the document, number of pages and so on. In certain embodiments, the computer can comprise certain application software and the computer can produce the print data with the application software. Examples of such application software consistent with certain embodiments of the invention include, but not limited to, a word processor software, a spread sheet software, a presentation software, an e-mail software and the like.

Further, the computer produces a print job according to the print data. In certain embodiments, the print job can include data of number of copies, number of pages, range of prints, zoom size and so on. In certain embodiments, the print job can include the print data. For example, the print job can include the data of contents of document A, pages 1-12 out of pages 1-15, A4 size, 3 copies, no zoom. In this case, contents of document A, pages 1-15 and A4 size are also the print data. In certain embodiments, the print job can include data according to certain page description language (“PDL”). Examples of the PDL consistent with certain embodiments of the invention include, but not limited to, Post Script™, PCL, RIPS, ESC/C and the like. In certain embodiments, the computer can comprise certain application software and the computer can produce the print job with the application software. Examples of such application software consistent with certain embodiments of the invention include, but not limited to, a printer driver software, a combination of the printer driver software and the other application software such as a word processor software, a spread sheet software, a presentation software and the like.

Further, the computer transfers the print job to the first printer.

The first printer is connected with the computer. The first printer prints documents, drawings, text and the like generally corresponding to the print job transferred from the computer. Examples of the first printer consistent with certain embodiments of the invention include, but not limited to, thermal printers (e.g., dye sublimation printers), ink jet printers, laser printers, and/or silver halide printers.

In certain embodiments, the first printer can be configured to be able to control the second printer connected with the first printer. In certain embodiments, the first printer can have a function of host in order to control the second printer connected with the first printer. In certain embodiments, the first printer can comprise USB host and the second printer can be connected with the first printer through the USB host. The first printer transfers the print job to the second printer.

The second printer is connected with the first printer. The second printer prints documents, drawings, text and the like generally corresponding to the print job transferred from the first printer. Examples of the second printer consistent with certain embodiments of the invention include, but not limited to, thermal printers (e.g., dye sublimation printers), ink jet printers, laser printers, and/or silver halide printers.

The first printer and the second printer are configured to be able to use same PDL. If the first printer and the second printer are configured to be able to use same PDL, the first printer can be different kind of printer from the second printer.

In the case that the computer transfers the print job to the first printer, the first printer receives the print job from the computer, the first printer prints according to the print job and the first printer transfers the print job to the second printer. The second printer receives the print job from the first printer and the second printer prints according to the print job.

In certain embodiments, the printing system can comprise more printers. In certain embodiments, the third printer can be connected with either the computer, the first printer or the second printer. In certain embodiments, all printers can be connected as a series connection. In the case that the third printer is connected with the second printer, the second printer can be configured to be able to control the third printer. The second printer can have a function of host in order to control the third printer connected with the second printer. The second printer can comprise USB host and the third printer can be connected with the second printer through the USB host. The second printer can transfer the print job to the third printer connected with the second printer.

In certain embodiments, the third printer can be configured to be able to use the same PDL as the first printer and the second printer. In certain embodiments, all printers included in the printing system can be configured to be able to use same PDL. If the first printer, the second printer and the third printer are configured to be able to use same PDL, the third printer can be different kind of printer from the first printer and/or the second printer.

A method for printing by the above printing system comprises a print data producing step which produces the print data by the computer, a print job producing step which produces the print job according to the print data by the computer, a first transferring step which transfers the print job from the computer to the first printer, a second transferring step which transfers the print job from the first printer to the second printer which is connected to the first printer, and a printing step which prints according to the print job by the first printer and the second printer. The first printer and the second printer are configured to be able to use same PDL.

In certain embodiments, the print job can be divided to several jobs and each printer can print according to each of the several jobs. For example, in the case that the printing system includes only two printers, the first printer and the second printer, the print job can be divided to two print jobs which are a first print job and a second print job. The first print job is for the first printer and the second print job is for the second printer. The first printer prints according to the first print job and the second printer prints the prints according to the second print job.

In certain embodiments, the print job can be divided to several print jobs evenly. For example, in the case that the printing system includes three printers connected in a series connection and the print job produced by the computer includes the data of 900 copies, the print job can be divided equally to three print jobs which are a first print job including the data of 300 copies, a second print job including the data of 300 copies and a third print job including the data of 300 copies. The first printer can print 300 copies according to the first print job, the second printer can print 300 copies according to the second print job and the third printer can print 300 copies according to the third print job.

In certain embodiments, the computer can divide the print job into several print jobs on the basis of the number of printers included in the printing system. In certain embodiments, the computer can divide the print job into several print jobs evenly on the basis of the number of printers included in the printing system. In certain embodiments, the computer can transfer all of the divided print jobs to the first printer and the first printer can print according to the divided first print job for the first printer and can transfer the one or more divided print jobs other than the divided first print job for the first printer to the second printer. The second printer can print according to the divided second print job for the second printer.

In certain embodiments, the computer can detect the number of printers included in the printing system by transferring signal to the printers and receiving the signal from the printers. In certain embodiments, the operator can input the number of the printers included in the printing system into the computer.

In certain embodiments, the first printer can divide the print job into several print jobs on the basis of the number of printers included in the printing system. In certain embodiments, the first printer can divide the print job into several print jobs evenly on the basis of the number of printers included in the printing system. In certain embodiments, the computer can transfer the print job to the first printer and the first printer can divide the print job into several print jobs, can print according to the divided first print job for the first printer and can transfer the one or more divided print jobs other than the divided first print job for the first printer to the second printer. The second printer can print according to the divided second print job for the second printer.

In certain embodiments, the first printer can detect the number of printers included in downstream of the first printer by transferring signal to the printers of downstream and receiving the signal from the printers of downstream. In certain embodiments, the first printer can receive the data of number of printers included in the printing system from the computer.

In certain embodiments, several printers included in the printing system can divide the print job into several print jobs. For example, in the case that the printing system includes three printers connected in a series connection and the print job produced by the computer includes the data of 900 copies, the computer can transfer the print job to the first printer and the first printer can divide the print job into the first print job including the data of 300 copies and the second print job including the data of 600 copies. The first printer can obtain data of 300 copies of the first print job by dividing 900 (copies) by 3 (number of printers). The first printer can print 300 copies according to the first print job and transfer the second print job to the second printer. The second printer can receive the second print job from the first printer and divide the second print job into the third print job including the data of 300 copies and the fourth print job including the data of 300 copies. The second printer can obtain data of 300 copies of the third print job by dividing 600 (copies) by 2 (number of printers other than the first printer). The second printer can print 300 copies according to the third print job and transfer the fourth print job to the third printer. The third printer can print 300 copies according to the fourth print job. In certain embodiments, each printer can comprise the data of number of printers included in the printing system. In certain embodiments, the computer the first printer, the second printer and/or other printer can transfer the data of number of printers included in the printing system.

In certain embodiments, the print job may not be divided to several jobs and each printer can print according to a part of the print job. For example, in the case that the printing system includes three printers connected in a series connection and the print job produced by the computer includes the data of 900 copies, the print job may be not divided and the print job can be transferred to the first printer from the computer. The first printer can print 300 copies according to a part of the print job including the data of 900 copies and transfer the print job including the data of 900 copies to the second printer. The first printer can obtain the data of 300 copies as a part of the print job by dividing 900 (copies) by 3 (number of printers). The second printer can receive the print job including the data of 900 copies, print 300 copies according to a part of the print job and transfer the print job including the data of 900 copies to the third printer. The second printer can obtain the data of 300 copies as a part of the print job by dividing 900 (copies) by 3 (number of printers). The third printer can receive the print job including the data of 900 copies, print 300 copies according to a part of the print job. The third printer can obtain data of 300 copies as the part of the print job by dividing 900 (copies) by 3 (number of printers). In certain embodiments, each printer can comprise the data of number of printers included in the printing system. In certain embodiments, the computer the first printer, the second printer and/or other printer can transfer the data of number of printers included in the printing system.

In certain embodiments, the print job may not be divided to several jobs and each printer can print according to the identical print job. For example, in the case that the printing system includes three printers connected in a series connection and the print job produced by the computer includes the data of 900 copies, the print job may be not divided and the print job can be transferred to the first printer from the computer. The first printer can print 900 copies according to the print job including the data of 900 copies and transfer the print job including the data of 900 copies to the second printer. The second printer can receive the print job including the data of 900 copies, print 900 copies according to the print job and transfer the print job including the data of 900 copies to the third printer. The third printer can receive the print job including the data of 900 copies, print 900 copies according to the print job.

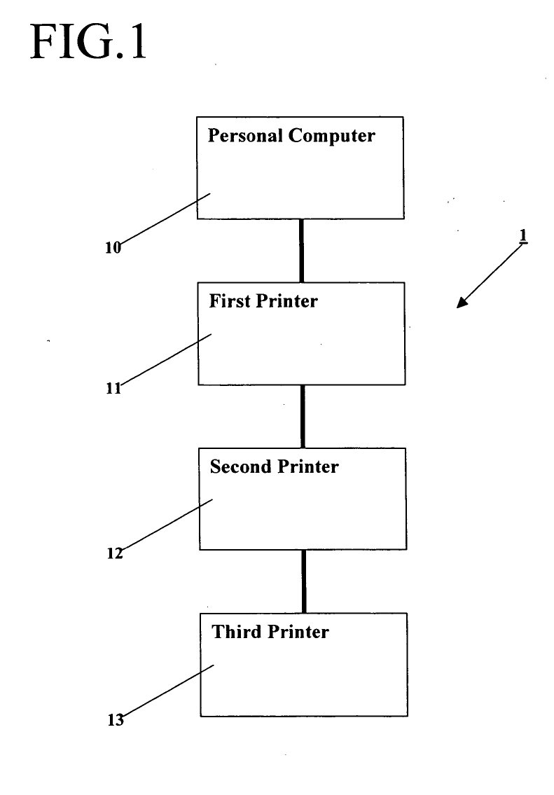

In certain embodiments, as illustrated in FIG. 1, the printing system 1 comprises a personal computer 10, a first printer 11, a second printer 12 and a third printer 13. In certain embodiments, the personal computer 10, the first printer 11, the second printer 12 and the third printer 13 can be connected by a twisted pair cable through LAN according to Ethernet. In certain embodiments, the personal computer 10, the first printer 11, the second printer 12 and the third printer 13 are connected in a series connection. In other words, the first printer is connected with the personal computer 10, the second printer 12 is connected with the first printer 11 and the third printer 13 is connected with the second printer 12.

In certain embodiments, the personal computer 10 can be a PC/AT compatible machine and can comprise Windows™ as an operating system (“OS”) and Microsoft Word™ as a word processor software of an application software. In certain embodiments, the personal computer 10 can produce a print data by using the Windows™ and the Microsoft Word™. In certain embodiments, the personal computer 10 can comprise a printer driver software. In certain embodiments, the personal computer 10 can produce a print job by processing the print data by the printer driver software, the Windows™ and the Microsoft Word™.

In certain embodiments, the first printer 11 can be a laser printer. In certain embodiments, the first printer 11 can comprise USB host and can be configured to be able to control an apparatus connected with the first printer through the USB host. The second printer 12 can be connected through the USB host of the first printer 11 and the first printer 11 can control the second printer 12.

In certain embodiments, the second printer 12 can be a laser printer. In certain embodiments, the second printer 12 can be a same kind of printer as the first printer 11. In certain embodiments, the second printer 12 can comprise USB host and can be configured to be able to control an apparatus connected with the first printer through the USB host. The third printer 13 can be connected through the USB host of the second printer 12 and the second printer 12 can control the third printer 13.

In certain embodiments, the third printer 13 can be a laser printer. In certain embodiments, the third printer 13 can be a same kind of printer as the first printer 11 and/or the second printer 12.

All of the first printer 11, the second printer 12 and the third printer 13 are configured to be able to use Post Script™ as PDL.

In certain embodiments, certain print data including data of contents of document X, pages 1-8, A4 size can be produced by the personal computer 10 using the Windows™ and the Microsoft Word™. Next, a print job including the print data (contents of document X, pages 1-8, A4 size) and 300 copies, no zoom, print range of pages 1-2 out of pages 1-8 can be produced according to the print data by the personal computer 10 using the printer driver software, the Windows™ and the Microsoft Word™. Then, the print job can be transferred from the personal computer 10 to the first printer 11.

In certain embodiments, the first printer 11 can detect the number of printers included in the printing system 1 by transferring signal to the printers of downstream (the second printer 12 and the third printer 13) and receiving the signal from the printers of downstream (the second printer 12 and the third printer 13). By doing such, the first printer 11 can obtain the data of number of printers included in the printing system 1. The number of printers in the printing system 1 is three.

In certain embodiments, the first printer 11 can receive the print job including the data of 300 copies from the personal computer 10. In certain embodiments, the first printer 11 may not divide the print job and can calculate the number of copies which the first printer 11 should print. The calculation can be done by dividing 300 (copies) by 3 (number of printers). Therefore, the number of copies which the first printer 11 should print is 100. Then, the first printer 11 can print 100 copies according to a part of the print job including the data of 300 copies. The first printer 11 can transfer the print job including the data of 300 copies and the data of 3 printers included in the printing system 1 to the second printer 12.

In certain embodiments, the second printer 12 can receive the print job including the data of 300 copies and the data of 3 printers included in the printing system 1 from the first printer 11. In certain embodiments, the second printer 12 may not divide the print job and can calculate the number of copies which the second printer 12 should print. The calculation can be done by dividing 300 (copies) by 3 (number of printers). Therefore, the number of copies which the second printer 12 should print is 100. Then, the second printer 12 can print 100 copies according to a part of the print job including the data of 300 copies. The second printer 12 can transfer the print job including the data of 300 copies and the data of 3 printers included in the printing system 1 to the third printer 13.

In certain embodiments, the third printer 13 can receive the print job including the data of 300 copies and the data of 3 printers included in the printing system 1 from the second printer 12. In certain embodiments, the third printer 13 may not divide the print job and can calculate the number of copies which the third printer 13 should print. The calculation can be done by dividing 300 (copies) by 3 (number of printers). Therefore, the number of copies which the third printer 13 should print is 100. Then, the third printer 13 can print 100 copies according to a part of the print job including the data of 300 copies.

In certain embodiments, since each of the first printer 11, the second printer 12 and the third printer 13 can print 100 copies almost simultaneously, 300 copies can be printed almost three times as fast as printing by only one printer.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for printing by a system comprising at least one computer and a first printer and a second printer, comprising:
producing a print data by the computer,
producing a print job according to the print data by the computer,
transferring the print job from the computer to the first printer,
transferring the print job from the first printer to the second printer which is connected to the first printer,
printing prints according to the print job by the first printer and the second printer, and
wherein the first printer and the second printer are configured to be able to use same page description language (PDL).

2. The method of printing of claim 1, wherein the first printer is configured to be able to control the second printer.

3. The method of printing of claim 2, wherein the first printer comprises USB host.

4. The method of printing of claim 1, wherein the print job is divided to a first print job for the first printer and a second print job for the second printer,
and wherein the first printer prints according to the first print job and the second printer prints according to the second print job.

5. The method of printing of claim 1, wherein the print job is not divided to several print jobs,
and wherein the first printer and the second printer print according to the identical print job.

6. A printing system comprising:
at least one computer producing a print data and producing a print job according to the print data,
a first printer connected with the computer and
a second printer connected with the first printer, and
wherein the first printer and the second printer are configured to be able to use same page description language (PDL) and,
wherein in the case that the computer transfers the print job to the first printer, the first printer transfers the print job to the second printer and the first printer and the second printer print according to the print job.

7. The printing system of claim 6, wherein the first printer is configured to be able to control the second printer.

8. The printing system of claim 7, wherein the first printer comprises USB host.
